(19) United States
(12) Patent Application Publication
(10) Pub. No.: US 2014/0046457 A1
(43) Pub. Date: Feb. 13, 2014

(54) SYSTEM AND RELATED METHOD TO FACILITATE PROCESS CONTROL

(71) Applicant: RENEWABLE PROCESS TECHNOLOGIES LLC, Devens, MA (US)

(72) Inventors: Wesson Taber, Haverrhill, MA (US); Christopher Sandusky, Shewsbury, MA (US); James Banks, Mansfield, MA (US)

(21) Appl. No.: 13/936,113

(22) Filed: Jul. 5, 2013

Related U.S. Application Data
(60) Provisional application No. 61/668,339, filed on Jul. 5, 2012.

(51) Int. Cl. G05B 19/05

(52) U.S. Cl. CPC G05B 19/056
USPC 700/2

(57) ABSTRACT

A system and related method to facilitate the programming of a PLC without requiring a physical connection of the PLC to the device used to program it. The system includes a database and a group of functions embodied in one or more computer programs. The functions enable a user to convert industrial process information of a process worksheet into PLC programming language. The system also enables a user to generate test documents associated with the controlled industrial process. This methodology enables a robust and structured workflow for software change control with new parameters established and any changes in the process control are captured by the system.

### BACKGROUND OF THE INVENTION

1. Field of the Invention

The present invention relates to the programming of programmable logic controllers. More specifically, the present invention relates to systems and methods to program programmable logic controllers associated with industrial processes.

2. Description of the Prior Art

Programmable logic controllers (PLCs) are used extensively in many industrial fields. In the world of industrial processes, they are used to control the operation of equipment to carry out specific process functions. PLCs are also used to monitor functions and report information associated with the process operations they regulate and monitor. PLCs are essentially computing devices programmed with software and real world inputs and outputs to enable the effective control and monitoring of complex processes. The software embodies instructions transmitted by the PLC to other devices and/or to manipulate information received from other devices.

The instructions embodied in the software of the PLC are typically established by two different types of people. Initially, a process engineer will lay out the operational design associated with an industrial process. That lay out is similar to a flow diagram but does not include the detail associated with a computer program. Therefore, a software engineer with special understanding of PLC programming languages generates the computer coding to program the PLC or multiple PLCs to carry out the operational design supplied by the process engineer.

It is not common for a process engineer to have sufficient capability to carry out the computer programming steps. It is also not common for a software engineer to have sufficient capability to generate the operational design features. The programming of a PLC to carry out an industrial process therefore requires two types of highly skilled people. The development of industrial process sensing and control operations can be very expensive in view of the need for these specialized skills. Moreover, it can be particularly difficult to find the people having these skills.

The need for the special skills of two different types of engineers is one limitation of PLC programming for industrial processes. Another limitation is the need to have a specific programming language for the manufacturer's PLC It makes it more difficult to create generic programming that may be used for multiple PLCs without acquiring each manufacturer's PLC. Further, it makes it more difficult to correct or modify programmed instructions for PLCs that have been placed in operation without requiring displacement of the PLC from the operation to make the physical connection to the programming tool.

Further, a significant portion of the life cycle costs associated with PLC programming is the need to accurately create test documents and perform the requisite testing to verify proper functioning of the program. Additionally during the effective useful life of the PLC programs and associated process systems, the systems or components require periodic changes. As with the initial PLC programs, these future changes require the creation of accurate test documents and the execution of requisite testing to verify proper functioning of the program and process. A significant portion of life cycle cost is that the process engineering and PLC programming resources that originally participated in PLC programming (or subsequent earlier software revisions) are unavailable.

It has become increasingly expensive to carry out the steps required to program PLCs for industrial processes. In particular, for relatively small sized organizations, it can be difficult to carry out such efforts without significant financial and manpower resources. As a result, it is increasingly difficult for all but the most sophisticated and large organizations to carry out such process functions. It would be preferable to have an arrangement that reduces the cost and dedicated resources to carry out PLC programming functions in a range of process operations. It would also be preferable to have such an arrangement that enables effective analysis of programming compliance with process goals and instructions.

What is needed is a system and related method to carry out PLC programming for process operations. Such a system and method would not require a physical connection of the PLC to a PLC programming tool until the need to download the program to the PLC. Further, what is needed is a system and related method to carry out PLC programming using skilled process engineers and PLC programmers in a cost effective manner and regardless of the size of the organization desirous of having the programming conducted and independent of the specific type of PLC. What is also needed is such a system and related process that can be used and carried out remote from the location where the process development is generated.

### SUMMARY OF THE INVENTION

It is an object of the present invention to provide a system and related method to carry out PLC programming for process operations without requiring a physical connection of the PLC to a PLC programming tool. It is also an object of the present invention to provide a system and related method to carry out PLC programming using skilled process engineers and PLC programmers in a cost effective manner regardless of the size of the organization needing the PLC programming capability and independent of the type of PLC to be programmed. Further, it is an object of the invention to provide such a system and related process that can be used and carried out remote from the location where the process development is generated.

These and other objects are achieved by the present invention, which is a computer-based system to translate operational process instructions into PLC programming for a variety of PLCs and without the need to connect the programming tool used as part of the system with a PLC to be programmed until required. The system and method allow for compliance control and assurance in the form and content of process worksheets, the translation of the information contained in such worksheets into a set of instructions in a programming language of one or more selectable PLCs and the operation of the PLCs. The system may be accessed locally or remotely to perform the steps carried out to conduct the PLC programming steps. A user may perform the programming steps directly using the system. Alternatively, the PLC programming may be carried out by a separate party as a programming service. Maintenance and updating of the system may be carried out by a single entity or by a plurality of entities.

The system includes a computing device, a PLC programming interface tool, a database for containing information associated with operational processes, PLC features and/or PLC programming information. The method includes the steps of establishing a first interface for the purpose of enabling operational process worksheet information, establishing a second interface for the purpose of enabling PLC programming, translating process worksheet information into PLC instruction software, from the PLC instruction software generation of worksheets for the purpose of testing the functionality of a programmed PLC and evaluating the operation of the PLC during the process for which it was created.

The database is configured to organize process information in a format that allows for information updates, information processing and information output controllable by a user. The database includes an expandable set of tables with relationships and programming designed to enable the translation of process instructions into PLC programming language and to translate PLC feedback into process control information. The tables contain PLC programming instruction information including, but not limited to, specific PLC interface requirements. The database is arranged to allow for changes in PLC information, as well as additions and deletions of PLC devices of a variety of PLC providers. The database includes access authorization restrictions to ensure that only designated personnel can input or change information. The access to the information contained in the database may be more widespread than access to the information change function. Any changed conditions or information is stored for later reviewed as desired.

The present invention further includes computer programming to implement steps associated with accessing the information of the database and producing outputs associated with the performance of the PLC programming or other functions of interest involving use of the process/PLC information of the database. Principal steps of the method carried out after receipt of an operational process worksheet include, but are not limited to: 1) creating a new application; 2) establishing process information input tags; 3) creating a User Interface Table (UIT) of the database; 4) configuring the UIT for all operational process inputs and outputs, units of measure, tags, process motors, equipment modules, valves and any other information required for a particular operational process; 5) generating input/output, alarm, interlock, controller, transition and sequence lists of the process worksheet; 6) reviewing the lists for quality assurance and safety; 7) converting the generated lists into PLC programming code; 8) generating test documents in compliance with process and process control testing standards; and 9) auditing the system for new and changed information associated with the process and/or one or more relevant PLCs. Additional optional steps of the method include, but are not limited to, distributing reports for any process change control to prompt review/approval as a function of authorization level and capturing in the database all programming revisions.

The invention includes the use of one or more computer-readable media comprising computer-executable instructions that, when executed, direct a computing system to maintain the database and permit, pursuant to access limitations, use of the database and the UIT to carry out the PLC programming function. Other computer-executable instructions of the media enable a user to access the database to obtain test reports and change control information.

The combination of the database and the programming function embodied in software enables an industrial process engineer to establish process rules and instructions, have those rules and instructions translated into PLC programming, implement that PLC programming to establish the process operations, and monitor the operations and the process instructions, including generating test documents for that purpose. These and other advantages of the present invention will become apparent upon review of the following detailed description, the accompanying drawings and the appended claims.

### BRIEF DESCRIPTION OF THE DRAWINGS

FIG. 1 is a simplified representation of a computing system suitable for carrying out the functions of the present invention as described herein.

FIG. 2 is a simplified flow diagram representing primary functions of the PLC programming and test reporting system of the present invention.

FIG. 3 is an example worksheet that may be converted into PLC programming using the present invention.

FIG. 4 is a display of a first screen representing the initial interface for a user to access the system of the present invention to program a PLC.

FIG. 5 is a display of a second screen representing a user interface for establishing whether a PLC to be programmed is physically connected to the computing system used to program the PLC.

FIG. 6 is a display of a third screen representing a UIT of process control inputs for an example industrial process associated with processing methanol.

FIG. 7 is a display of a fourth screen representing a UIT of process control inputs for the methanol processing example.

FIG. 8 is a display of a fifth screen representing a UIT process control inputs for the methanol processing example.

FIG. 9 is a display of a sixth screen representing a UIT of process control inputs for the methanol processing example.

### DETAILED DESCRIPTION OF THE PREFERRED EMBODIMENT

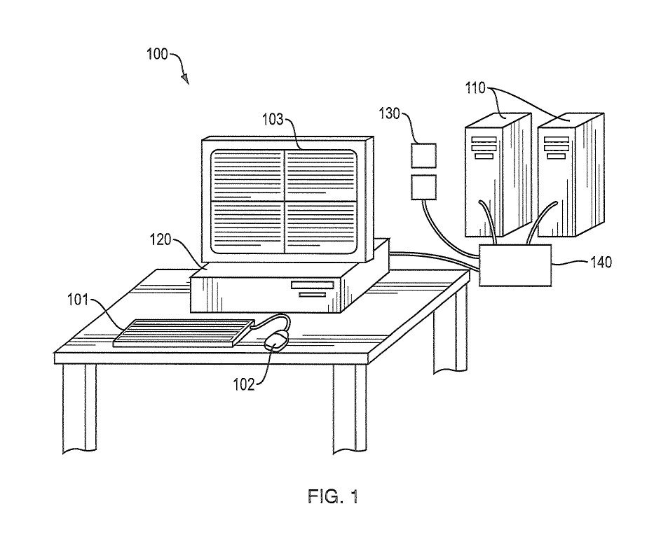

The present invention is a system and method for programming a PLC to carry out industrial process steps. The system, method and related database are embodied in a computing system programmed to perform functional steps associated with the storing of the information for the purpose of accessing it and carrying out instructions based on that information. Any type of computing system suitable to store information in the amount of interest and to generate and/or initiate instructions of interest on the information may be employed and is represented generally in FIG. 1. The computer system 100 shown is only one example of a suitable computing environment and is not intended to suggest any limitation as to the scope of use or functionality of the invention. For example, the computer system 100 may be associated with local or remote computing means, such as one or more central computers, such as server 110 in a local area network, a metropolitan area network, a wide area network, or through intranet and internet connections.

The computer system 100 may include one or more discrete computer processor devices, represented by desktop computer 120, for example. Examples of well known computing devices that may be suitable for use with the invention include, but are not limited to, personal computers, server computers, hand-held or laptop devices, tablet computers, multiprocessor systems, microprocessor-based systems, set top boxes, programmable consumer electronics, network PCs, minicomputers, mainframe computers, distributed computing environments that include any of the above systems or devices, and the like. The computer system 100 may include computer devices operated by one or more users, such as through a desktop, laptop, or servers, and/or one or more providers of services corresponding to one or more functions of the invention.

The server 110, the computer processor 120, or a combination of both may be programmed to include one or more of the functions of the invention system. The database of the present invention for gathering, storing and making accessible the process and/or PLC programming information, is represented by Database 130. For the purpose of the description of the present invention, a database is a collection of stored data that are logically related. Although there are different types of databases, and the Database 130 of the present invention may be any of such types, it is preferably a database with a database management system, comprising tables made up of rows and columns. Data stored in the tables are accessed or updated using database queries submitted to the database system.

Database 130 may be associated with the server 110, the computer processor 120, other computing devices, or any combination thereof, and includes information related to the use of the system of the present invention. The Database 130 may be associated with a single computing device or a plurality of devices. The Database 130 may be centrally located or it may be distributed locally or widely. The Database 130 is populated and updated with the information to be described herein in a format to be described herein. All of the devices may be interconnected through one or more signal exchange devices, such as router/switch 140.

The invention may be described in the general context of computer-executable instructions, such as program modules, being executed by a computer such as the computer system 100. Generally, program modules include routines, programs, objects, components, data structures, etc. that perform particular tasks or implement particular abstract data types. As indicated above, the system of the present invention may also be practiced in distributed computing environments where tasks are performed by remote processing devices that are linked through a communications network or other data transmission medium. In a distributed computing environment, program function modules and other data may be located in both local and remote computer storage media including memory storage devices.

The computer processor 120 and interactive drives, memory storage devices, databases, including but not limited to the Database 130, and peripherals may be interconnected through one or more computer system buses. The system buses may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The computer system 100 typically includes a variety of computer readable media. Computer readable media can be any available media that can be accessed by computer system 100 and includes both volatile and non-volatile media, removable and non-removable media. By way of example, and not limitation, computer readable media may comprise computer storage media and communication media. Computer storage media include volatile and non-volatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100.

The computer system 100 further includes computer storage media in the form of volatile and/or non-volatile memory such as Read Only Memory (ROM) and Random Access memory (RAM). RAM typically contains data and/or program modules that are accessible to and/or operated on by computer processor 120. That is, RAM may include application programs, such as the functional modules of the system of the present invention, and information in the form of data. The computer system 100 may also include other removable/non-removable, volatile/non-volatile computer storage and access media. For example, the computer system 100 may include a hard disk drive to read from and/or write to non-removable, non-volatile magnetic media, a magnetic disk drive to read to and/or write from a removable, non-volatile magnetic disk, and an optical disk drive to read to and/or write from a removable, non-volatile optical disk, such as a CD-ROM or other optical media. Other removable/non-removable, volatile/non-volatile computer storage media that can be used in the computer system 100 to perform the functional steps associated with the system and method of the present invention include, but are not limited to, magnetic tape cassettes, flash memory cards, digital versatile disks, digital video tape, solid state RAM, solid state ROM, and the like.

The drives and their associated computer storage media described above provide storage of computer readable instructions, data structures, program modules and other data for the computer processor 120. A user may enter commands and information into the computer processor 120 through input devices such as a keyboard 101 and a pointing device 102, commonly referred to as a mouse, trackball or touch pad. Other input devices (not shown) may include a microphone, joystick, game pad, satellite dish, scanner, or the like. These and other input devices are connected to the computer processor 120 through the system bus, or other bus structures, such as a parallel port, game port or a universal serial bus (USB), but is not limited thereto. A monitor 103 or other type of display device is also connected to the computer processor 120 through the system bus or other bus arrangement. In addition to the monitor 103, the computer processor 120 may be connected to other peripheral output devices, such as printers (not shown). Commands and information may be entered by one or more users any one or more of whom may be located in the same or different locations. Commands and information may be entered at designated or random times.

The computer processor 120 may be configured and arranged to perform functions and steps embodied in computer instructions stored and accessed in any one or more of the manners described. The functions and steps, such as the functions and steps of the implementation of the database and its use in regard to the present invention, individually or in combination, may be implemented as a computer program product tangibly as computer-readable signals on a computer-readable medium, such as any one or more of the computer-readable media described. Such computer program product may include computer-readable signals tangibly embodied on the computer-readable medium, where such signals define instructions, for example, as part of one or more programs that, as a result of being executed by the computer processor 120, instruct the computer processor 120 to perform one or more processes or acts described herein, and/or various examples, variations and combinations thereof. Such instructions may be written in any of a plurality of programming languages, for example, XML, JAVA, C++, or any other language suitable for the purpose of the present invention, or any of a variety of combinations thereof. Information entry may be effected using such programming languages as well as other applications including for example and in no way limited thereto, database programs ACCESS and DB2. The computer-readable medium on which such instructions are stored may reside on one or more of the components described above and may be distributed across one or more such components.

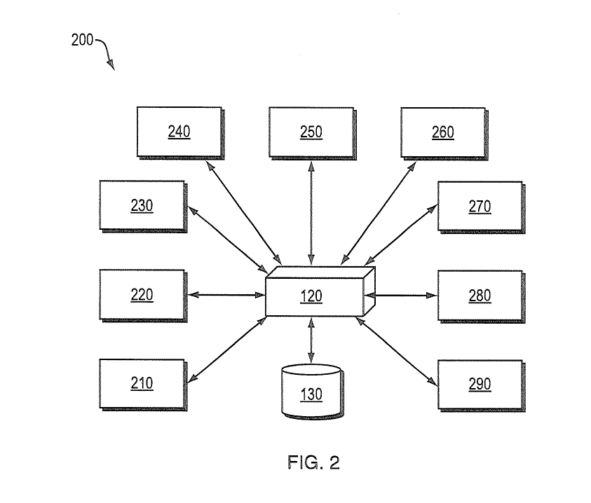

With reference to FIG. 2, a PLC programming system 200 of the present invention includes a plurality of functions embodied in one or more computer programs executable through the computer processor 120 of the computer system 100, wherein signals are exchanged between the functions and the computer processor 120, and between the database 130 and the functions through the computer processor 120. Functions of the system 200 include a local information input function 210, a remote information input function 220, an optional process worksheet generation function 230, a worksheet review function 240, a worksheet information translator function 250, a PLC programming function 260, a communication function 270, a test documents output function 280 and a change order control function 290. All or a portion of the identified functions may be employed in carrying out steps to program a selectable PLC and to receive, analyze and report information received from a PLC and/or other devices associated with an industrial process.

The local information input function 210 of the system 200 enables a user to input into the Database 130 information for industrial process steps and tools, as well as information about PLCs available from a plurality of PLC manufacturers. The information is input through a user interface of a computing device that forms part of the computer system 100 under control of the entity having control of the Database 130. The local input function may also be used to input process worksheets in any form of interest including, but not limited to, Excel format for the purpose of programming a PLC for an industrial process. In particular, the local information input function 210 is used to configure one or more user interface tables of the Database 130 with information such as inputs and outputs, alarms, process device interlock information, controller design and functionality, transitions and sequence lists. A primary administrator of the system 200 may be established with authorization to access and modify the Database 130, through programming represented by the local information input function 210.

As with the local information input function 210, the remote information input function 220 of the system 200 provides a user interface of a computing device that is not part of the computer system 100 under control of the entity having control of the Database 130 but that is instead enabled to connect to the Database 130 with permission. The remote information input function 220 permits a party, such as a customer, to access the Database 130 through a connection arrangement, such as through the internet, but not limited thereto. The remote user can input information of the same type input using the local information input function 210. That includes, but is not limited to, worksheets having complete or partial process information to be used in the programming of a PLC. The system 200 administrator may permit the customer to access the Database 130 directly to input information with suitable security and access permission arrangements. Alternatively, the remote information input function 220 may be configured to force the remote user to transmit the process information to the administrator for the administrator to input received information to the Database 130 so that the administrator retains control over security and access.

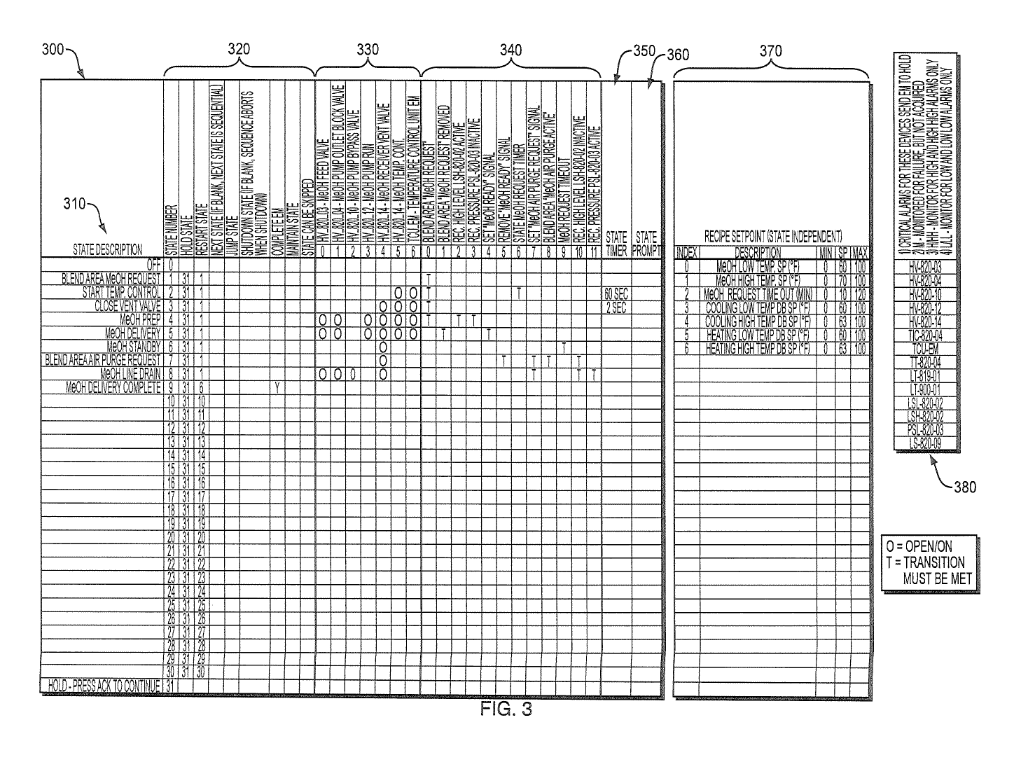

The optional process worksheet generation function 230 permits the controller of the Database 130 to create a process worksheet based on information provided through the user interface. The person responsible for the process design typically would fill out the process worksheet for translation into a PLC program. The worksheet is a familiar interface for the organization of process steps and transitions that are then translated into PLC code. Instructions and training are provided on how to properly use the process worksheet and on how to implement the customer's process. FIG. 3 shows an example worksheet 300 generated for the purpose of enabling the programming of a PLC to prepare and transfer methanol as part of a larger industrial process.

The worksheet review function 240 is configured to review the content of a generated or supplied worksheet to determine whether there are any errors, inconsistencies or inefficiencies that may require correction or modification. The Database 130 includes information of process worksheet standards and general process quality assurance and safety guidelines. Such guidelines may be modified only in conformance with sufficient access authorization. There are written instructions on best practices for the programming of the process worksheet. There is a guidelines tool for the project.

The worksheet information translator function 250 is configured to convert the content of a satisfactory worksheet of the Database 130 into a format suitable for carrying out PLC programming. Specifically, the translator function 250 translates spreadsheet cell content, which may be numerical, alphabetical, symbolic and/or equation in form into programming language compatible with the PLC or PLCs selected to perform the controlling operations of the industrial process.

The PLC programming function 260 is configured to program one or more selected PLCs associated with the industrial process to carry out instructions corresponding to the process steps described in the worksheet. The PLC programming function 260 engages with the one or more PLCs through a communication connection that may be wired or wireless. The PLC programming function 260 includes any hooks necessary to enable the transfer of electrical signals from the computing system 100 to the PLC or PLCs in a language that has been established through the worksheet information translator function 250. The PLC programming function 260 is further configured to confirm suitable communication with the PLC/PLCs and satisfactory delivery of the programming instructions to the PLC/PLCs. The communication interface for the PLC to the computer system 100 may be accomplished using an industrial communication driver that is available and utilized depending on the PLC manufacturer.

The communication function 270 provides for the interaction between the computing system 100 and an operator or user of the system 200 of the present invention who is located remotely from the computing system 100. The communication function 270 may be provided as a wireless connection or a wired connection to a computer device under the control of the operator/user. The communication function 270 permits authorized access to the system 200 of the invention based on policies established by its administrator.

The test documents output function 280 is configured to generate one or more test documents representative of the output from the programmed PLC/PLCs based on sensed information obtained from the industrial process including, but not limited to, temperature, pressure, time, concentration, pH, valve status, and the like. The test documents output function 280 is configured to process that acquired information and produce a report reflective of the condition of the process controlled by the PLC/PLCs. The format of the test documents is either regulated by industry standards, default or customized to provide information of interest to the industrial process owner.

The change order control function 290 relates to authorized control functions previously described herein and is further configured to regulate and enable the mechanism by which changes are made in the process instructions of a worksheet, who is designated to authorize process changes, the order of change control authority, and the specific mechanism for translating changed process steps of a modified worksheet into changes in PLC programming. Specifically, the change order control function 290 is configured by an authorized administrator to designate individuals of the administrator organization, the customer organization or both who are permitted to access the worksheet through the worksheet review function 240 and/or the worksheet generator function 230. The change order control function 290 is further configured to enable worksheet changes by such authorized individuals and then transfer a revised or updated worksheet to the worksheet information translator function 250 for the purpose of enabling PLC reprogramming through the PLC programming function 260. Confirmation of changed PLC programming is confirmed through an updated test documents generated through the test documents output function 280.

The system 200 may be activated for use periodically, regularly, continuously or sporadically. The worksheet information may be gathered on a regular or sporadic basis and may be defined by the system administrator and/or the customer. A check of the quality of the information gathered through the information input functions 210 and 220 may be performed regularly or sporadically. All of the remaining functions may be performed regularly or sporadically. All results produced may be retained in the Database 130.

The system 200 represented in FIG. 2 may be embodied in one or more computer programs and one or more computer systems. It may be embodied in software, hardware, firmware or any combination thereof. The functions shown may be performed through the computer processor 120 as a single computing mechanism, or through a plurality of computer processors represented by processor 120. The system 200 may include one or more embodiments of the Database 130, which Database 130 may be embodied in the computer processor 120 or in one or more other computer systems in electronic communication with the computer processor 120. It is to be noted that information gathered, stored and/or manipulated through the system 200, may be used without specific presentation on a graphical user interface of the computer system 100. For example, the output of information may be transferred among computer devices, or within a networked computing system, without specific presentation on a display.

The Database 130 is used to store all process information in original and any adjusted form, as well as any information of interest related to the process instructions, PLC programming, test documents and change orders. An example of a worksheet 300 that has been generated separately or through the worksheet generation function 230 is shown in FIG. 3. The worksheet 300 includes content suitable for use in the generation of instructions associated with a process for preparing and transferring methanol as part of a more comprehensive process. It is to be understood that the worksheet 300 is a simple example and that the process invention may be used to generate PLC programming for much more complex processes. In regard to the example worksheet of FIG. 3, column 310 lists primary operational steps of the methanol process. The content of the columns of column set 320 identify operational step state condition options, with individual populated cells of those columns containing information about the specific state condition of interest for each identified operational step. The content of the columns of column set 330 lists the physical devices used to carry out the operational state conditions for the identified operational steps. Those devices associated with a particular step have a designation in the particular corresponding cell, including whether the device should be on or not. The physical devices listed include valves and temperature controllers. Of course, any other sorts of devices may be controlled using the system 200 of the present invention. The content of the columns of column set 340 define transient conditions and/or associated descriptions of operational conditions for the identified steps. The information contained therein includes indicia of when transitions occur such as, for example, the opening or closing of a particular valve when the methanol has reached a certain temperature.

With continuing reference to FIG. 3, column 350 includes information for time periods associated with indicated process steps. Column 360 includes information associated with the timing of when a change of state of a step is to occur. The content of the columns of column set 370 provide information about the regulation of the temperature of the methanol required as part of the process including, for example, several temperature conditions to be met to initiate a change in state of a process of column 310. Finally, column 380 lists the tag numbers of devices that may be used in the process including those devices of column set 330.

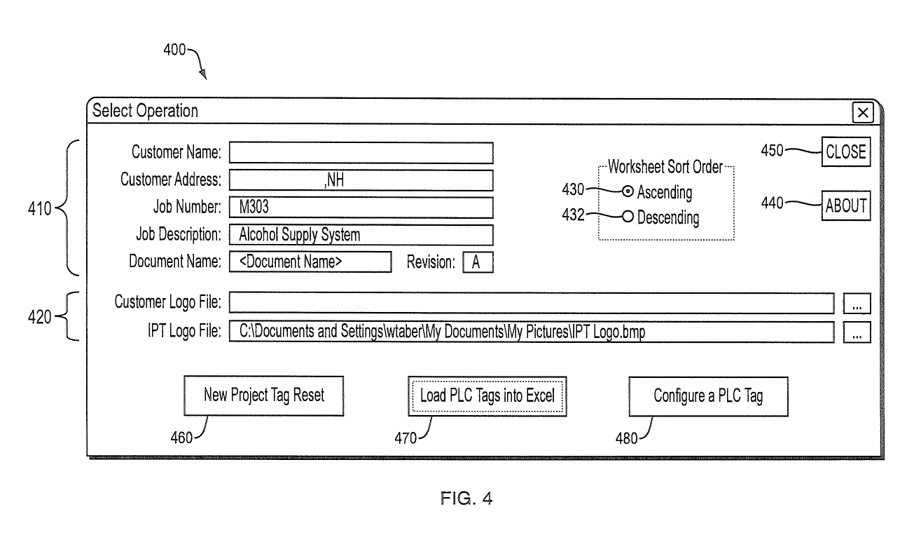

There are three major computer program components used to implement the system 200 and access to and usage of the Database 130. They are: 1) the Database 130 schema; 2) a User Interface Table (UIT); and 3) a Dynamic Link Library (DLL) that interfaces between the Database 130 and the UIT. In one embodiment, the Database 130 schema is defined in a file established in DB2. In an alternative embodiment, the Database 130 schema may be defined in a file established in Microsoft Excel spreadsheet. Those of ordinary skill in the art will recognize that other programming means may be employed to establish the Database 130 schema associated with the Database 130 design and architecture. The UIT is defined in a file established in Java Server Pages (JSP), Hyper Text Markup Language (HTML) code, and/or JavaScript code. In this embodiment, the majority of the files for the GUI are written manually and compiled on a server using a JAVA compiler to create HTML pages. Those of ordinary skill in the art will recognize the specific programming required to generate the GUI as represented in accompanying FIGS. 4-9. The present invention is not limited to the specific programming languages identified herein.

The DLL provides a programmatic interface between the Database 130 and the UIT. The DLL is preferably implemented in JAVA but is not limited thereto. The files of the DLL may be generated manually or they may be compiled using the Java compiler language to examine the other files including, but not limited to, JAVA, which may then be used to generate the JAVA class files. The programming necessary to establish the DLL suitable for linking the Database 130 to the UIT may be prepared by one of ordinary skill in the art based on the detailed information provided for the worksheets and through the UIT screen captures and associated text also provided herein. Any modifications to the Database 130 made through any UIT are retained by the Database 130 so that all process control operation changes are retained and available for subsequent review.

FIGS. 4-9 are graphical representations of the screens viewed by a local or remote user of the system to program one or more PLCs of an industrial process. The system 200 embodied in the computer program as described herein is activated or launched by clicking on an icon representing the program, or otherwise initiating application opening through desktop or other computer application interface activation methods well known to users of computer programs. Access to the system 200 and the Database 130 may be regulated by conventional authentication and access rules, such as by the particular role of the user seeking access to the system 200. For example, the system 200 may be arranged to grant full access for modification of process instructions, step modifications and programming algorithm adjustments. Alternatively, a user may be granted access solely to observe information, including obtaining test documents. Other role types and access restrictions may be established and changed from time to time based on guidelines established by the system 200 administrator.

Upon activating the system 200, the computer processor 120 enables the user to observe on display 103 a first screen as shown in FIG. 4. The first screen, as with all other screens created through use of the system 200, is a UIT, which enables the user to see one or more interactive display representations of tables and entities of the Database 130, and to manipulate the content of the Database 130 through user inputs, generally either with keystrokes of the keyboard 101, and/or clicking or clicking and dragging with the mouse 102 icons, categories, items, elements, formulas, and the like represented on the display 103.

The initial system access screen 400 represented in FIG. 4 presents the user with a simple mechanisms for entry into the system 200, which, when activated, enable the user to either view content of the Database 130 or input new information for a new PLC programming activity, such as from an established worksheet or a worksheet to be generated. The UIT of the initial screen includes a group of input cells 410 for providing information about the customer for whom the industrial process PLC programming is to be performed. Alternatively, the customer may be authorized to carry out the programming process of the system 200 and would likely put its own information in cells 410. Additional customer and/or administrator identifiers may be inserted in cells 420 so that output reports may include customer and/or administrator logos. The user may establish the order of worksheets to be used for accessing process information in the course of the PLC programming as being ascending or descending dependent upon which of radio buttons 430 and 432 is engaged. Clicking of the “About” link 440 enables the user to see information about the system 200. Clicking on the “Close” link 450 closes the program. In order to proceed with a PLC programming activity, the user selects one of links 460, 470 and 480 by clicking thereon.

Clicking on any of links 460-480 allows the user to access the tag database associated with equipment and/or operational parameters associated with the industrial process. The tag database is an area where every automated component is given a unique identifier or “tag” to make that component unique and properly addressed. Depending upon the type of device whether it is an Analog Input, Analog Output, Discrete Input, or a Discrete Output there will be an associate “dot” field for the configuration of that particular device. The dot fields are directly generated from the base tag and are additional parameters that can be configured for each individual tag. Example tags include unique identifiers for process equipment, equipment module tags (such as for a heater, for example), tags for valves (Discrete Outputs or Analog Outputs) in particular, discrete valve tag parameters, and so forth as described herein. Link 460 specifically enables the user to begin a new process control effort by clearing all subsequent tags and allowing the user to create new programming tag sets. That may be of interest to do when the user has a new industrial process to control and has no pre-existing programming parameters that would be applicable. Link 470 enables the user to access previously established programming tag sets that had been generated in the PLC for input of new information. Using the methanol transfer process as an example, the user may click on link 470 if another methanol transfer control program had been developed and there was a desire to start with it as a basis for a new transfer operation. Link 480 enables the user to create additional process parameter tags that may form part of a particular process control program of interest.

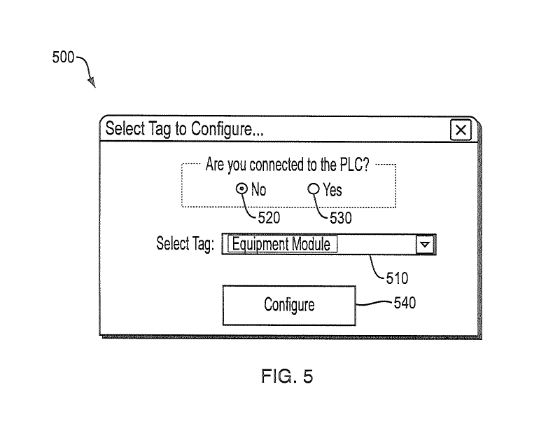

By clicking on link 470, as indicated by the dotted lines around that link in FIG. 4, the user is directed to UIT screen 500 of FIG. 5. At that screen, the user is prompted to select a particular programming tag set at drop down menu 510. The tag set options are defined and may be revised, updated or amended through either of links 460 and 480 of screen 400. A further feature of UIT screen 500 is the opportunity for the user to define whether or not a PLC to be programmed is physically connected to the computer system 100 or not by selecting one of the radio buttons labeled “No” 520 and “Yes” 530. This is a desirable feature of the present invention in that allows for PLC programming without requirement that the PLC be physically connected to the computer system 100. As a result, PLC programming functions may be carried out and completed without the obligation to acquire or have on hand the PLC. That renders the process of the present invention more flexible and more efficient than any PLC programming tool requiring such a physical connection. Optionally, if link 480 had been selected at screen 400, the user is permitted to configure a new programming tag by clicking on link 540.

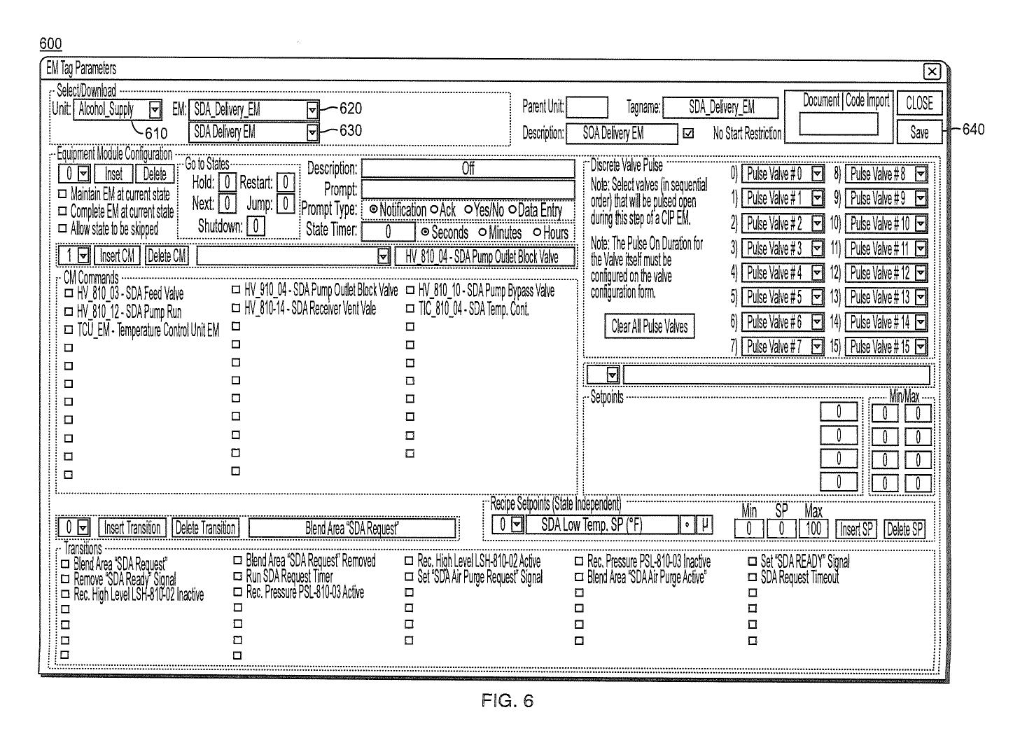

For the purpose of providing an example of the functionality of the system 200 of the present invention, a first PLC tag selected is the Equipment Module tag shown in the drop down menu 510. The selection of that tag generates a new UIT screen 600 shown in FIG. 6, which is configured to enable the user to input operating characteristics of a particular piece of equipment used in the industrial process. Drop down menu 610 provides a list of equipment to be controlled, wherein “Alcohol_Supply” is the example shown. It is to be understood that the list of equipment may be unlimited and defined only by those with authorized access to the system 200. Particular details about the equipment and its functionality are further made available at drop down menus 620 and 630. The remainder of screen 600 includes an array of operating characteristics for that particular piece of equipment of the industrial process to be input by the user. That information may be entered manually or populated through a link to an existing worksheet, such as worksheet 300. Upon completion of entry of the input information, link 640 is clicked to save those entries. Link 650 may then be clicked to close screen 600 and return to screen 500 for another tag input operation if necessary. The format and content selection options listed on screen 600 are examples only and may be revised as desired by the system 200 administrator.

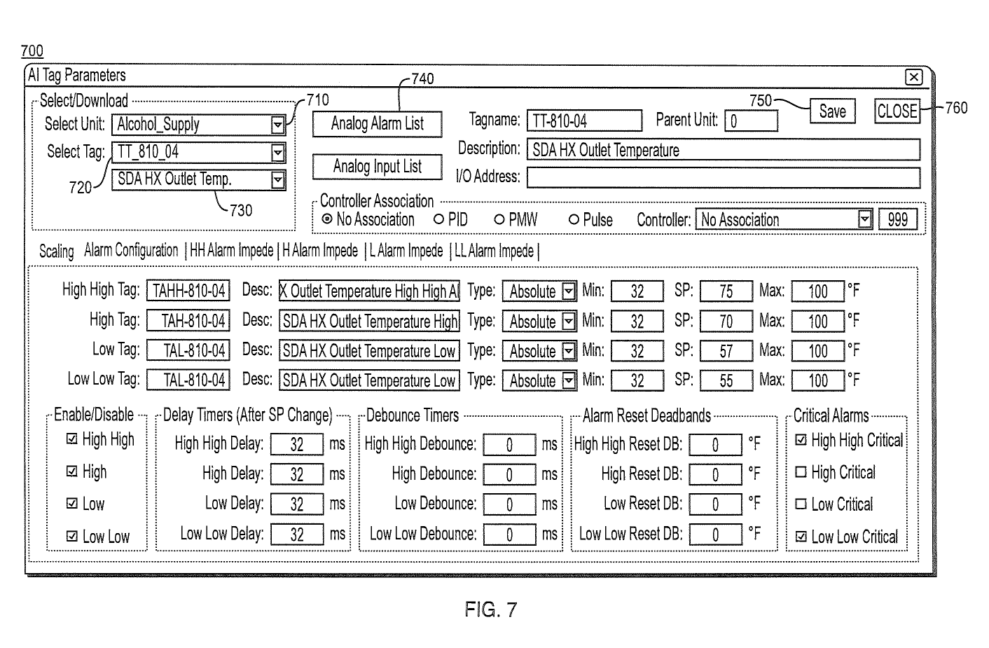

In addition to the option to repeat a plurality of equipment module tagging procedures, the user has the option at screen 500 to select a different programming tag at drop down menu 510. A second example tag module provides for Analog Input parameter information input enabled through UIT screen 700 shown in FIG. 7. That screen is configured to enable the user to input operating conditions required by the industrial process and enabled or regulated by a particular piece of equipment used in the process. Drop down menu 710 provides a list of equipment to be controlled, wherein “Alcohol_Supply” is the example shown, which may be the same equipment associated with the EM Tag of screen 600. It is to be understood that the list of equipment may be unlimited and defined only by those with authorized access to the system 200. Particular details about the equipment and its functionality are further made available at drop down menus 720 and 730. The remainder of screen 700 includes an array of operating characteristics for that particular piece of equipment of the industrial process to be input by the user. That information may be entered manually or populated through a link to an existing worksheet, such as worksheet 300. One example parameter that may be enabled is an alarm to be activated through link 740 based on variants of the operating parameters input into the programming function through screen 700. Upon completion of entry of the input information, link 750 is clicked to save those entries. Link 760 may then be clicked to close screen 700 and return to screen 500 for another tag input operation if necessary. The format and content selection options listed on screen 700 are examples only and may be revised as desired by the system 200 administrator.

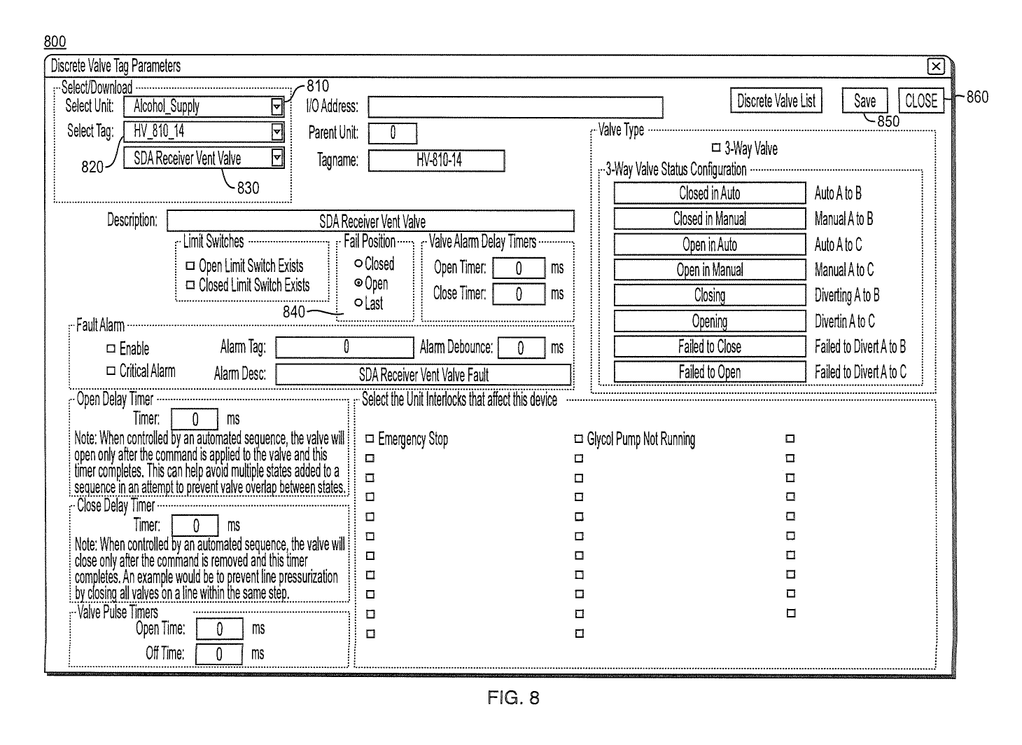

In addition to the option to repeat a plurality of analog input tagging procedures, the user has the option at screen 500 to select further another programming tag at drop down menu 510. A third example tag module provides for Discrete Valve parameter information input enabled through UIT screen 800 shown in FIG. 8. That screen is configured to enable the user to input valve operating conditions required for a particular piece of equipment used in the process. Drop down menu 810 provides a list of equipment to be controlled, wherein “Alcohol_Supply” is the example shown, which may be the same equipment associated with the EM Tag of screen 600. It is to be understood that the list of equipment may be unlimited and defined only by those with authorized access to the system 200. Particular details about the equipment and its functionality are further made available at drop down menu 820. The specific valve to be controlled is selected at drop down menu 830. The remainder of screen 800 includes an array of operating characteristics for that selected valve in association with the identified piece of equipment to be input by the user. That information may be entered manually or populated through a link to an existing worksheet, such as worksheet 300. One example parameter that may be enabled is a default state of the valve in the event of an equipment or process deviation exceeding some specified limits. That default state selection of the valve may be made from the set of radio buttons at 840. Upon completion of entry of the input information, link 850 is clicked to save those entries. Link 860 may then be clicked to close screen 800 and return to screen 500 for another tag input operation if necessary. The format and content selection options listed on screen 800 are examples only and may be revised as desired by the system 200 administrator.

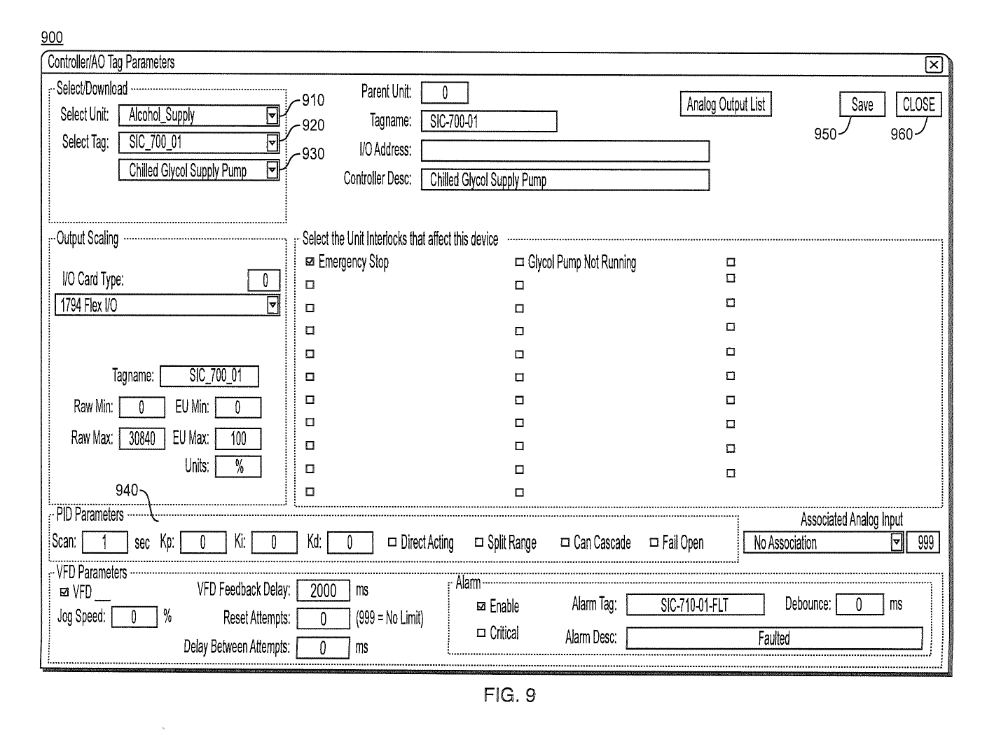

A fourth and final example input option for the user of the system 200 of the present invention is UIT screen 900 shown in FIG. 9. That screen is configured to enable the user to input Analog Output parameter information including, for example, desired output characteristics associated with the operation of a particular piece of equipment used in the process. Drop down menu 910 provides a list of equipment to be controlled, wherein “Alcohol_Supply” is the example shown, which may be the same equipment associated with the EM Tag of screen 600. It is to be understood that the list of equipment may be unlimited and defined only by those with authorized access to the system 200. Particular details about the equipment and its functionality are further made available at drop down menus 920 and 930. The remainder of screen 900 includes an array of desired output conditions associated with that particular piece of equipment of the industrial process to be input by the user. That information may be entered manually or populated through a link to an existing worksheet, such as worksheet 300. One example parameter that may be enabled is an indication of the type of process controller is used in conjunction with the equipment as determined through selection of one of the radio buttons of button set 940, which information may be useful in determining what form of output information is available. Upon completion of entry of the input information, link 950 is clicked to save those entries. Link 960 may then be clicked to close screen 900 and return to screen 500 for another tag input operation, if necessary, or confirmation of completion of all input information required to enable programming of the PLC. The format and content selection options listed on screen 900 are examples only and may be revised as desired by the system 200 administrator.

The information that is entered into the forms is translated into PLC programming language using a standard programming software. For example Visual Basic for Applications or Visual Basic would be the translation software that is programmed to take the tabular data and translate the data into a PLC code structure for download to a PLC. The user entered data is translated into “dot” fields or parameters for download into the PLC. The PLC has pre-built “engines” that take the dot fields data and run the data to implement a process. The pre-built engines are subroutines that “loop,” allowing for the execution of the parameter driven Graphical User Interface (GUI) to allow for efficient programming. The PLC software is unchanged and the information that is entered into the GUI is downloaded as parameters and entered into the “engine” and run accordingly. The concept is very similar to structured programming in VBA or Visual Basic but a standard PLC platform does not leverage the power of procedures or function calls for process applications.

With PLC “object” subroutines written and reusable, the logic can be tested, verified, and validated once. Subsequently, it is only the properties of the individual object which require verification. Additionally, graphical objects and popup windows are created to represent the PLC objects by type. For example, because all discrete valves are of the“discrete valve” object type, they all utilize the same popup window and valve graphic. Characteristic differences are reflected by divergence in the object's property configuration within the PLC object tag.

The structure introduced through the use of object oriented PLC code opens the door to automated document generation. Because objects of the same type share the same properties, lists can be generated of the object tags and their properties. Links between Microsoft Excel and the Allen Bradley online PLC are established using Digital Data Exchange (DDE). As such, the documentation can “program” the PLC and just as importantly, the PLC can update the documentation. In essence, the code is self-verifying. There is a significant time savings and money savings by utilizing a sequence of operations which can be manipulated through a database and then downloaded directly to the PLC with little to no reprogramming required.

The test documents that are generated by the system are the actual tabular data that were inputted by the user. The idea is that the data that are used to program the system will be used as the test documents. To generate the test documents, they are printed using the test document creation button and signature and date fields are added to the document as part of the test document creation button. The test documents can be printed to Adobe®, to a printer or to a like paper or paperless technology for verification after the system is running. The user can verify system operation and, after verification, sign and date the document attesting to the fact that the system has been verified and tested.

Having thus described at least one illustrative embodiment of the invention, various alterations, modifications and improvements are contemplated by the invention. Such alterations, modifications and improvements are intended to be within the scope and spirit of the invention. Accordingly, the foregoing description is by way of example only and is not intended as limiting. The invention's limit is defined only in the following claims and the equivalents thereto.

What is claimed is:

1. A computer-implemented system for programming a PLC to control an industrial process, wherein the computer-implemented system includes programming to carry out instructions to enable a computing device to perform functions comprising:
a) an information input function to input information into a database coupled to the computing device, wherein the information includes desired operating conditions and selectable equipment of the industrial process;
b) a worksheet information translator function to translate the input information into a worksheet format and convert the information content of the worksheet into a programming language compatible with the programming requirements of the PLC; and
c) a PLC programming function to program the PLC to carry out control instructions of the industrial process with the translated input information.

2. The computer-implemented system of claim 1 further comprising a test documents output function to generate one or more documents representative of information received from the PLC or other devices associated with the industrial process corresponding to operating conditions of the industrial process controlled by the PLC.

3. The computer-implemented system of claim 1 further comprising a worksheet generator function for creating one or more worksheets representative of the industrial process to be controlled based on the information input into the database.

4. The computer-implemented system of claim 3 wherein the input information includes operational process inputs and outputs, units of measure, tags, process motors, equipment modules and valves.

5. The computer-implemented system of claim 1 wherein the information input function into a database and worksheets which follows a translator function to translate and convert the information content of the database and worksheets into a programming language compatible with the programming requirements of the PLC and performing these operations while the computer system is not connected to the PLC.

6. A method for programming a PLC to control an industrial process, the method comprising the steps of:
a) inputting into a database information including desired operating conditions and selectable equipment of the industrial process;
b) translating the input information into a worksheet format and converting information content of the worksheet into a programming language compatible with the programming requirements of the PLC; and
c) programming the PLC to carry out control instructions of the industrial process with the translated input information.

7. The method of claim 6 further comprising the step generating one or more documents representative of information received from the PLC or other devices associated with the industrial process corresponding to, operating conditions of the industrial process controlled by the PLC.

8. The method of claim 6 further comprising the step of creating one or more worksheets representative of the industrial process to be controlled based on the information input into the database.

9. The method of claim 8 wherein the input information includes operational process inputs and outputs, units of measure, tags, process motors, equipment modules and valves.

10. The method of claim 6 wherein the steps of translating and programming are carried out while the PLC is not connected to a computer system associated with the industrial process.
